(19) United States
(12) Patent Application Publication
(10) Pub. No.: US 2006/0038805 A1
(43) Pub. Date: Feb. 23, 2006

(54) Methods of signal mode determination for electronic display devices

(75) Inventors: Liu Yun-Wen, Pingjhen City (TW); Wu Rong-Wha, Sihhu Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/195,431

(22) Filed: Aug. 2, 2005

(30) Foreign Application Priority Data
Aug. 18, 2004 (TW) 93124820

(51) Int. Cl. G09G 5/00

(52) U.S. Cl. 345/204

(57) ABSTRACT

Methods of signal mode determination for electronic display devices for determining a mode of an input display signal. A first display signal is first received. The first display signal comprises first pixels and each first pixel has hue values. The first display signal is determined as a first mode if one of the following conditions is true, else as a second mode. The first condition is if the ratio of the first pixels having the same hue value reaches a first predetermined ratio. The second condition is if the ratio of the first pixels having the hue values within a static hue value range reaches a second predetermined ratio.

### BACKGROUND

The invention relates to methods of signal determination for electronic display devices, and in particular to signal mode determination.

With the progress of signal processing technology, electronic display devices, such as liquid crystal display (LCD), are widely employed in different fields. Currently, a display signal, such as a frame, is processed based on pixels for presentation in an electronic display device. Thus, pixels in a display signal input to an electronic display device can be analyzed and processed individually. For example, a recording device may only record images when objects in a display signal move, thus reducing recording time and resources.

If a display signal comprises signals with various signal modes, however, the display signal must be analyzed before image processing. The analysis is typically executed manually. Signal modes represent the content of a display signal, for example, text, graphics, or animation mode. FIG. 1 is a flowchart of a conventional method of signal mode determination. First, a display signal is received (step S10). Next, the signal mode of the display signal is determined manually (step S12). Finally, an image processing method is selected according to the determined signal mode. The image processing method is used to process images, including text or graphic enhancement method.

The conventional signal mode determination method has some drawbacks. Primarily, if the determination is executed manually, repeated manual operations may be necessary for signal mode determination. Additionally, manual operations reduce the automation in an image processing system, impeding the related applications of an electronic display device.

Thus, electronic display devices with display signal mode determination functions are desirable.

### SUMMARY

In an embodiment of display signal mode determination method, a first display signal is received. The first display signal comprises pixels and each pixel has hue values. The first display signal is determined as a first mode if one of the following conditions is met. If none of the conditions is met, the signal is determined to be a second mode. The first condition is if the ratio of the first pixels having the same hue value reaches a first predetermined ratio. The second condition is if the ratio of the first pixels having the hue values within a static hue value range reaches a second predetermined ratio.

### DESCRIPTION OF THE DRAWINGS

The present invention can be more fully understood by reading the subsequent detailed description and examples with references made to the accompanying drawings, wherein:

FIG. 1 is a flowchart of a conventional method of signal mode determination.

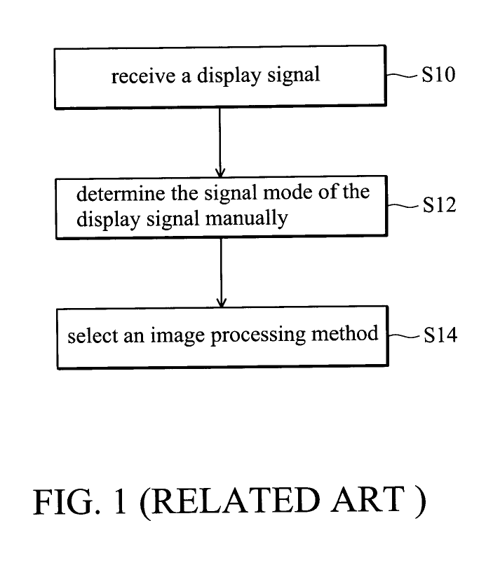

FIG. 2 is a flowchart of an embodiment of a method of signal mode determination for an electronic display device.

FIG. 3 is a detailed flowchart of an embodiment of a method of signal mode determination for an electronic display device.

FIG. 4 is a diagram of an embodiment of a machine-readable storage medium for storing a computer program providing a method of signal mode determination for an electronic display device.

FIG. 5 is a diagram of an embodiment of an electronic display device with signal mode determination function.

### DESCRIPTION

Methods of display signal mode determination for electronic display devices are provided. An embodiment of a method of signal mode determination for an electronic display device comprises determining a mode of a display signal input to the electronic display device.

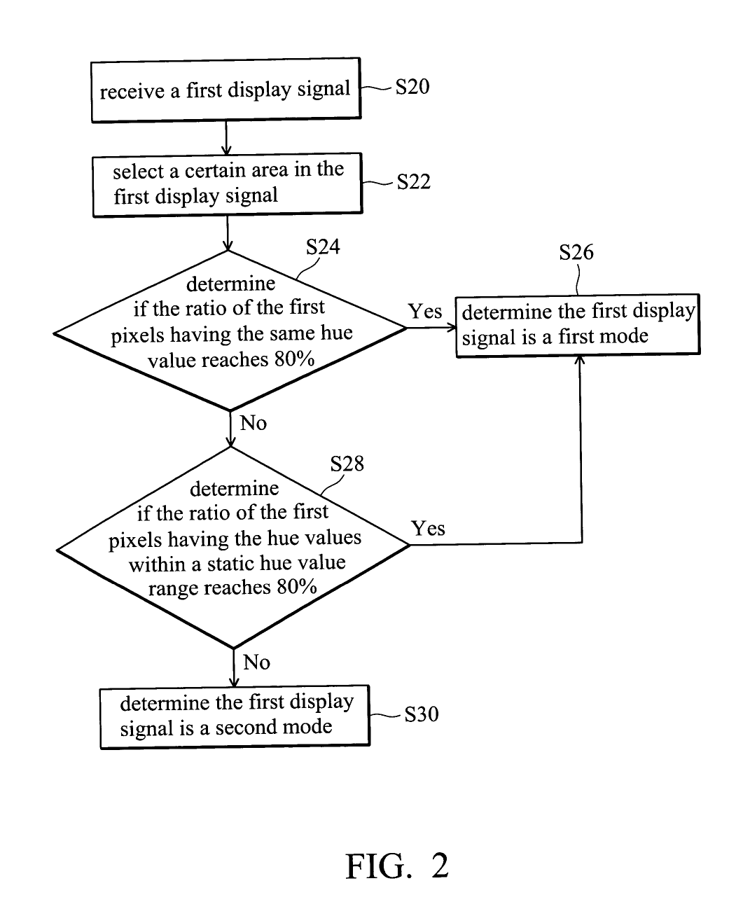

FIG. 2 is a flowchart of an embodiment of a method of signal mode determination for an electronic display device. First, a first display signal is received (Step S20). The first display signal comprises first pixels and each first pixel has hue values, such as the first, second, and third hue values, for example red, green, and blue (RGB) values. A certain area is then selected in the first display signal (step S22). Next, the first display signal is determined as a first mode if one of the following conditions is true, else as a second mode (step S24-S30). The first condition is if the ratio of the first pixels having the same hue value reaches a first predetermined ratio. The second condition is if the ratio of the first pixels having the hue values within a static hue value range reaches a second predetermined ratio. The determination is based on the first pixels within the selected certain area.

The static hue value range indicates a range of specific colors for displaying text in the electronic display device. For example, if a static hue value range for an electronic display device is (0-10), (60-70), (124-132), (192-200), (248-255), thus, the second condition is if the ratio of the first pixels having the hue values within (0-10), (60-70), (124-132), (192-200), (248-255) reaches a second predetermined ratio.

In some embodiments, the first and the second predetermined ratios are defined a's 80%. The first mode is text mode and the second mode is non-text mode. Thus, in step S24, it is determined if the ratio of the first pixels having the same hue value has reached 80% (step S24). If so, the first display signal is determined as a first mode (step S26). If not, the method proceeds to step S28. In step S28, it is determined if the ratio of the first pixels having the hue values within a static hue value range has reached 80%. If so, the first display signal is determined as the first mode (step S26). If not, the first display signal is determined as the second mode (step S30).

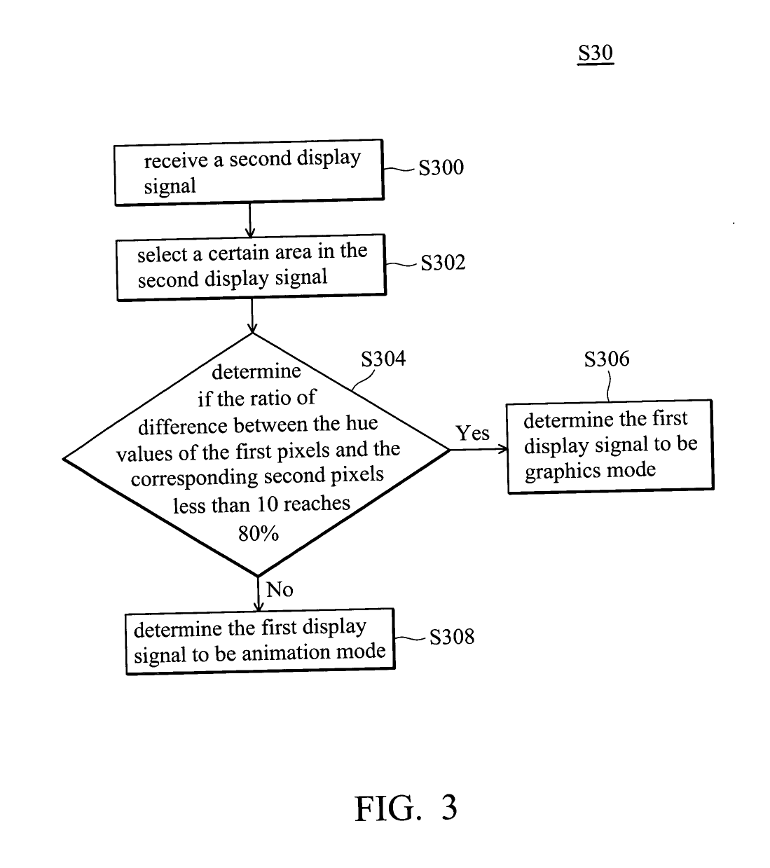

Referring to FIG. 3, FIG. 3 is a detailed flowchart of an embodiment of a method of signal mode determination for an electronic display device. If the first display signal is determined as the second mode (step 30), a second display signal is received (step S300). The second display signal comprises second pixels corresponding to the first pixels. The first and the second display signals are continuous signals. A certain area in the second display signal is then selected (step S302). If the ratio of difference between the hue values of the first pixels and the corresponding second pixels less than a predetermined difference reaches a third predetermined ratio, the first display signal is determined to be a third mode (step S306). If the ratio of difference between the hue values of the first pixels and the corresponding second pixels less than a predetermined difference does not reach the third predetermined ratio, the first display signal is determined as a fourth mode (step S308).

For example, the third predetermined ratio is 80% and the predetermined difference is 10. The third mode is graphics mode and the fourth mode is animation mode. Thus, in step S304, it is determined if the ratio of difference between the hue values of the first pixels and the corresponding second pixels less than 10 reaches 80% (step S304). If so, the first display signal is determined as graphics mode (step S306), if not, as animation mode (step S308). Here, the determination is based on the second pixels in the certain area.

Thereafter, a signal enhancement method is selected according to the determined signal mode. The signal enhancement method is applied to the first display signal for image processing.

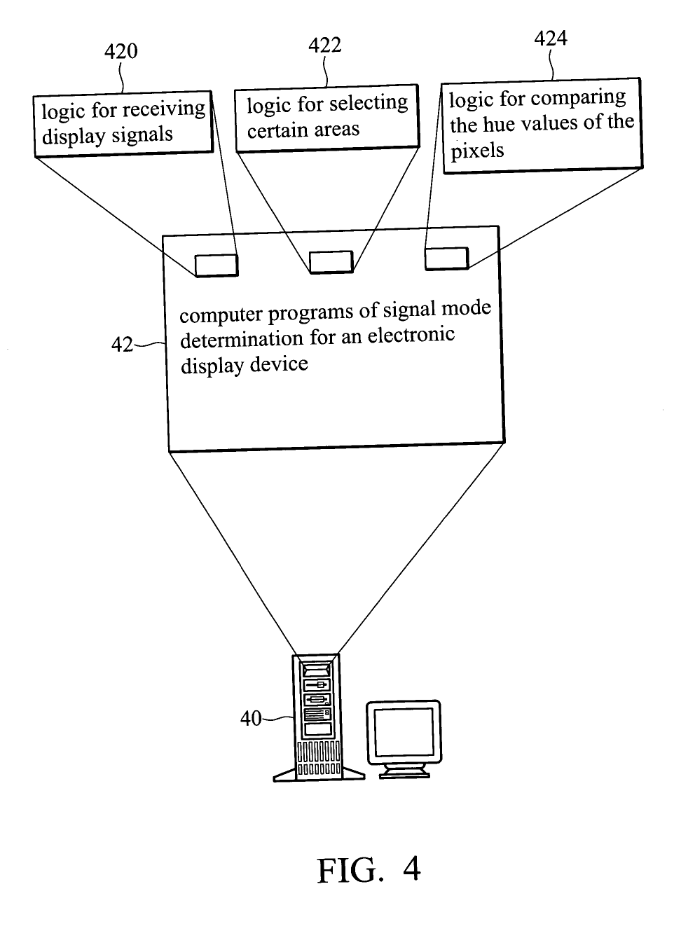

Machine-readable storage media is also provided. An exemplary embodiment of machine-readable storage stores computer programs that provide a method of signal mode determination for an electronic display device. Said computer programs may implement methods such as those previously described. FIG. 4 is a diagram of an embodiment of a machine-readable storage medium for storing a computer program providing a method of signal mode determination for an electronic display device. As shown in FIG. 4, machine-readable storage medium 40 stores a computer program 42. The computer program 42 mainly comprises logic for receiving display signals 420, selecting certain areas 422, and comparing the hue values of the pixels 424.

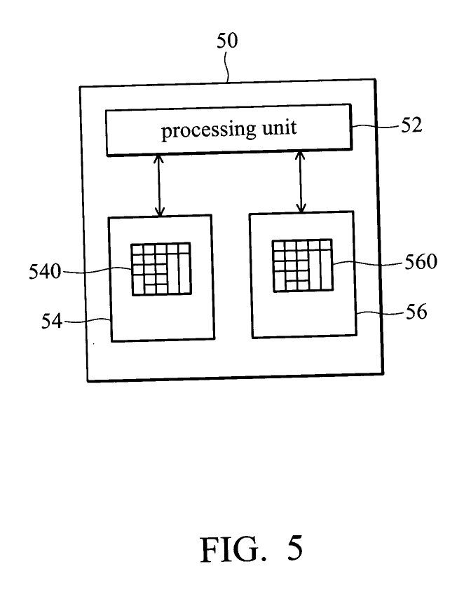

FIG. 5 is a diagram of an embodiment of an electronic display device with signal mode determination function. In some embodiments, an electronic display device 50 with signal mode determination function is provided. The electronic display device 50 comprises a processing unit 52. The processing unit 52 receives a first display signal 54. The first display signal 54 comprises first pixels, and each first pixel has hue values, such as a first, second, and third hue values, e.g. RGB. The processing unit 52 then selects a certain area 540 in the first display signal 54. The processing unit 52 determines the first display signal as a first mode if one of the following conditions is met. If none of the conditions is met, the signal is determined to be a second mode. The first condition is if the ratio of the first pixels having the same hue value reaches a first predetermined ratio. The second condition is if the ratio of the first pixels having the hue values within a static hue value range reaches a second predetermined ratio. The static hue value range indicates a range of certain colors for displaying text in the electronic display device. The determination is based on the first pixels in the certain area 540.

In some embodiments, the first mode is text mode and the second mode is non-text mode. If the first display signal is determined as the second mode, the processing unit 52 further receives a second display signal 56. The second display signal 56 comprises second pixels corresponding to the first pixels. The processing unit 52 selects a certain area 560 in the second display signal 56. The first and the second display signals 54 and 56 are continuous signals.

If the ratio of difference between the hue values of the first pixels and the corresponding second pixels less than a predetermined difference reaches a third predetermined ratio, the processing unit 52 determines the first display signal as a third mode, such as graphics mode. If the ratio of difference between the hue values of the first pixels and the corresponding second pixels less than a predetermined difference does not reach the third predetermined ratio, the processing unit 52 determines the first display signal as a fourth mode, such as animation mode.

Upon determination of the signal mode, the processing unit 52 may select a signal enhancement method according to the determined signal mode. The signal enhancement method is applied to the first display signal for image processing. The processing unit 52 can be implemented in a chip.

Thus, methods of signal mode determination for an electronic display device may potentially resolve the supposed inconvenience of conventional manual mode determination. The methods are particularly useful for a display signal with various signal modes.

Methods of the present invention, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing and embodiment of the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the invention. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method of signal mode determination for an electronic display device, determining a mode of an input display signal, comprising:
receiving a first display signal, wherein the first display signal comprises a plurality of first pixels, and each first pixel has at least one hue value; and
determining the first display signal as a first mode if one of the following conditions is true, else as a second mode;
if a ratio of the first pixels having the same hue value reaches a first predetermined ratio; and
if a ratio of the first pixels having the hue values within a static hue value range reaches a second predetermined ratio.

2. The method of signal mode determination for an electronic display device as claimed in claim 1, wherein the reception of the first display signal further selects a certain area therein.

3. The method of signal mode determination for an electronic display device as claimed in claim 1, wherein if the first display signal is determined as the second mode, the method further comprising:
receiving a second display signal, wherein the second display signal comprises a plurality of second pixels corresponding to the first pixels;
if a ratio of difference between the hue values of the first pixels and the corresponding second pixels less than a predetermined difference reaches a third predetermined ratio, determining the first display signal as a third mode; and
if the ratio of difference between the hue values of the first pixels and the corresponding second pixels less than a predetermined difference does not reach the third predetermined ratio, determining the first display signal as a fourth mode.

4. The method of signal mode determination for an electronic display device as claimed in claim 3, wherein the receiving of the second display signal further selects a certain area therein.

5. The method of signal mode determination for an electronic display device as claimed in claim 3, wherein the first and the second display signals are continuous signals.

6. The method of signal mode determination for an electronic display device as claimed in claim 1, further selecting a signal enhancement method according to the determined signal mode, wherein the signal enhancement method is applied to the first display signal for image processing.

7. The method of signal mode determination for an electronic display device as claimed in claim 3, wherein the first mode is text mode, the second mode is non-text mode, the third mode is graphics mode and the fourth mode is animation mode.

8. A machine-readable storage medium for storing a computer program providing a method of signal mode determination for an electronic display device, determining a mode of an input display signal, the method comprising:
receiving a first display signal, wherein the first display signal comprises a plurality of first pixels, and each first pixel has at least one hue value; and
determining the first display signal as a first mode if one of the following conditions is true, else as a second mode;
if a ratio of the first pixels having the same hue value reaches a first predetermined ratio; and
if the ratio of the first pixels having the hue values within a static hue value range reaches a second predetermined ratio.

9. The machine-readable storage medium as claimed in claim 8, wherein the reception of the first display signal further selects a certain area therein.

10. The machine-readable storage medium as claimed in claim 8, wherein if the first display signal is determined as the second mode, the method further comprising:
receiving a second display signal, wherein the second display signal comprises a plurality of second pixels corresponding to the first pixels;
if a ratio of difference between the hue values of the first pixels and the corresponding second pixels less than a predetermined difference reaches a third predetermined ratio, determining the first display signal as a third mode; and
if a ratio of difference between the hue values of the first pixels and the corresponding second pixels less than a predetermined difference does not reach the third predetermined ratio, determining the first display signal as a fourth mode.

11. The machine-readable storage medium as claimed in claim 10, wherein the reception of the second display signal further selects a certain area therein.

12. The machine-readable storage medium as claimed in claim 10, wherein the first and the second display signals are continuous signals.

13. The machine-readable storage medium as claimed in claim 8, further selecting a signal enhancement method according to the determined signal mode, wherein the signal enhancement method is applied to the first display signal for image processing.

14. The machine-readable storage medium as claimed in claim 8, wherein the first mode is text mode, the second mode is non-text mode, the third mode is graphics mode and the fourth mode is animation mode.

15. An electronic display device with signal mode determination function, comprising a processing unit to execute:
receiving a first display signal, wherein the first display signal comprises a plurality of first pixels, and each first pixel has at least one hue value; and
determining the first display signal as a first mode if one of the following conditions is true, else as a second mode;
if a ratio of the first pixels having the same hue value reaches a first predetermined ratio; and
if a ratio of the first pixels having the hue values within a static hue value range reaches a second predetermined ratio.

16. The electronic display device with signal mode determination function as claimed in claim 15, wherein the processing unit further selects a certain area in the first display signal and the processing unit executes the determination according to the first pixels in the certain area.

17. The electronic display device with signal mode determination function as claimed in claim 15, wherein if the first display signal is determined as the second mode, the processing unit further:
receiving a second display signal, wherein the second display signal comprises a plurality of second pixels corresponding to the first pixels;
if a ratio of difference between the hue values of the first pixels and the corresponding second pixels less than a predetermined difference reaches a third predetermined ratio, determining the first display signal as a third mode; and
if the ratio of difference between the hue values of the first pixels and the corresponding second pixels less than a predetermined difference does not reach the third predetermined ratio, determining the first display signal as a fourth mode.

18. The electronic display device with signal mode determination function as claimed in claim 17, wherein the processing unit further selects a certain area in the second display signal and the determination is executed according to the second pixels in the certain area.

19. The electronic display device with signal mode determination function as claimed in claim 17, wherein the first mode is text mode, the second mode is non-text mode, the third mode is graphics mode and the fourth mode is animation.

20. The electronic display device with signal mode determination function as claimed in claim 15, the processing unit further selecting a signal enhancement method according to the determined signal mode, wherein the signal enhancement method is applied to the first display signal for image processing.
